(19) United States
(12) Patent Application Publication
(10) Pub. No.: US 2010/0126466 A1
(43) Pub. Date: May 27, 2010

(54) Carburetor

(75) Inventor: Toshio Ikutame, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., Ltd., Atsugi (JP)

(21) Appl. No.: 12/591,032

(22) Filed: Nov. 5, 2009

(30) Foreign Application Priority Data
Nov. 26, 2008 (JP) 2008-300352

(51) Int. Cl. F02M 7/24

(52) U.S. Cl. 123/438

(57) ABSTRACT

To prevent back bleed in a carburetor including a slow fuel passage branched from a main fuel passage, in a carburetor for an engine in which a slow air intake port to introduce air into a slow air bleed passage opens on the side of a suction passage; a slow fuel passage is connected in the middle of a main fuel passage on the upstream side, joins the slow air bleed passage on the downstream side, and has an open end on the side of the suction passage; and the main fuel passage opens in a state where a main nozzle projects in a venturi part of the suction passage, wherein the slow air intake port is opened at a predetermined position of the venturi part having an inner diameter equal to or less than that of the suction passage at a position where the main fuel passage opens.

### BACKGROUND OF THE INVENTION

1. Field of the Invention

The present invention relates to a carburetor disposed in a fuel supply system of an engine. More particularly, it relates to a carburetor including a slow fuel passage branched from a main fuel passage.

2. Description of the Related Art

A carburetor disposed in a fuel supply system of a small-sized gasoline engine or the like has a constitution where, for example, as described in Japanese Unexamined Patent Publication No. 2001-27156 and shown in a vertical sectional view of FIG. 3, a fuel which has flowed from a float chamber (a constant fuel chamber) 2 into a slow fuel passage 6 during a low-speed operation passes through a slow jet nozzle 6a shown in a transverse sectional view of FIG. 4, enters a horizontal passage, and is mixed with air which has flowed through a slow air intake port 9B, a slow air bleed jet 9a and a slow air bleed passage 9, and the resultant air-fuel mixture is sucked and supplied into a suction passage 10 from a slow port 11 disposed close to a throttle valve 12.

However, it is known that in such a carburetor including the slow fuel passage 6 branched in the middle of a main fuel passage 4, a venturi negative pressure at the tip of a main nozzle 7 in an opening of the main fuel passage 4 at the full load of the engine noticeably surpasses a negative pressure near the slow air intake port 9B or the slow port 11, thereby causing a so-called back bleed phenomenon that air is sucked into a main fuel passage 4 side through the slow air intake port 9B and the slow port 11 and sucked out to the suction passage 10 together with the fuel through the main nozzle 7, to dilute the air-fuel mixture.

When such back bleed occurs, the stability of the engine is impaired, and hence an attempt is made to decrease the diameter of the slow jet nozzle 6a or the branched passage, thereby decreasing the amount of air flowing through the slow fuel passage 6. Moreover, as described in Japanese Unexamined Patent Publication No. 7-103074 and Japanese Unexamined Patent Publication No. 2001-27154, it is also known that under an emulsion pore of the main nozzle, a wall (a flange) is provided which comes in contact closely with the inner wall of a main well to block the connection between a main air chamber and the slow fuel passage 6.

In this way, the passage can be narrowed to such an extent that the stability of the engine is not impaired, whereby the back bleed can be alleviated to a certain degree. However, the back bleed cannot completely be prevented as long as there is a pressure difference between the venturi negative pressure of a position where the main nozzle 7 opens and the negative pressure near the slow air intake port 9B. Moreover, these problems are remarkable especially when an air cleaner has a large suction resistance in the carburetor having a small venturi size.

### SUMMARY OF THE INVENTION

The present invention has been developed to solve the above problems, and an object thereof is to prevent back bleed in a carburetor including a slow fuel passage branched from a main fuel passage by a simple constitution.

To achieve the object, according to the present invention, there is provided a carburetor for an engine in which a slow air intake port to introduce air into a slow air bleed passage opens on the side of a suction passage; a slow fuel passage is connected in the middle of a main fuel passage on the upstream side, joins the slow air bleed passage on the downstream side, and has an open end on the side of the suction passage; and the main fuel passage opens in a state where a main nozzle projects in a venturi part of the suction passage, wherein the slow air intake port is opened at a predetermined position of the venturi part having an inner diameter equal to or less than that of the suction passage at a position where the main fuel passage opens.

As described above, in the carburetor including the slow fuel passage branched from the main fuel passage, a difference between a venturi negative pressure in the opening of the main fuel passage and a negative pressure of the slow air intake port increases, thereby easily causing a back bleed phenomenon that air passed through the slow fuel passage is mixed with a supplied fuel, to dilute the fuel. However, according to the simple constitution where the slow air intake port is only provided at the predetermined position of the venturi part having the inner diameter equal to or less than that of the suction passage where the main fuel passage opens, a differential pressure between the slow air intake port and the opening side of the main fuel passage is eliminated, so that excessive air can be prevented from flowing through the slow fuel passage.

Moreover, in this carburetor, when the slow air intake port opens in the narrowest portion of the venturi part, the differential pressure between the slow air intake port and the opening of the main fuel passage can securely be eliminated.

Furthermore, in the carburetor of the present invention, even if the slow air intake ports open at two portions of the venturi part and a position on the upstream side of the venturi part, the excessive air can similarly be prevented from flowing through the slow fuel passage. In this case, the slow air intake port of a conventional carburetor can be left as it is, whereby portions to be modified can be minimized.

According to the present invention in which the slow air intake port is provided at the predetermined position of the venturi part, the back bleed can effectively be prevented while minimizing cost increase.

### BRIEF DESCRIPTION OF THE DRAWINGS

FIG. 1 is a transverse sectional view showing an embodiment of the present invention;

FIG. 2 is a transverse sectional view showing an application example of a carburetor of FIG. 1;

FIG. 3 is a vertical sectional view showing a conventional example; and

FIG. 4 is a transverse sectional view of a carburetor of FIG. 3.

### DESCRIPTION OF THE PREFERRED EMBODIMENTS

Hereinafter, the best mode for carrying out the present invention will be described with reference to the drawings.

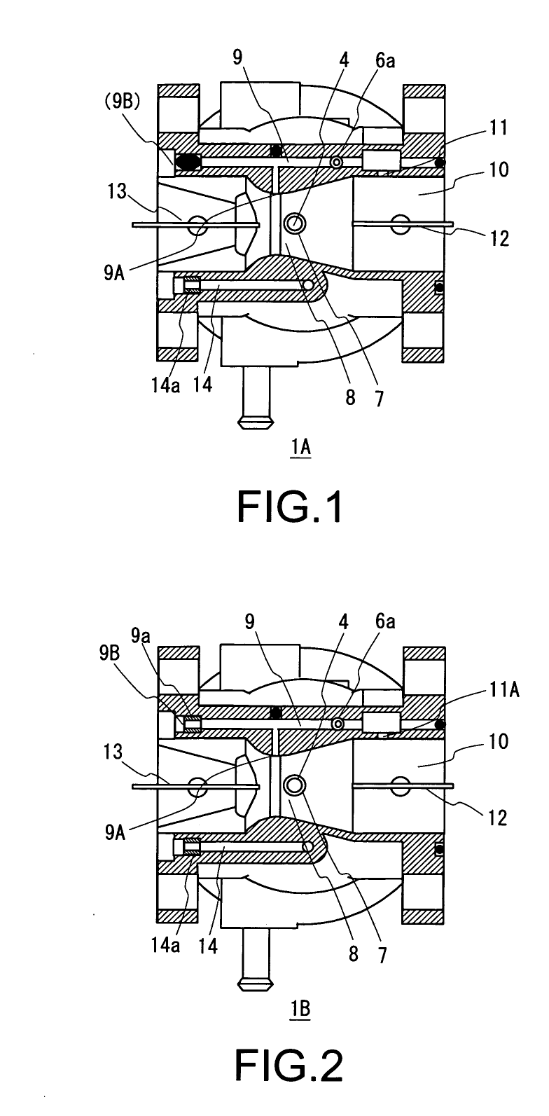

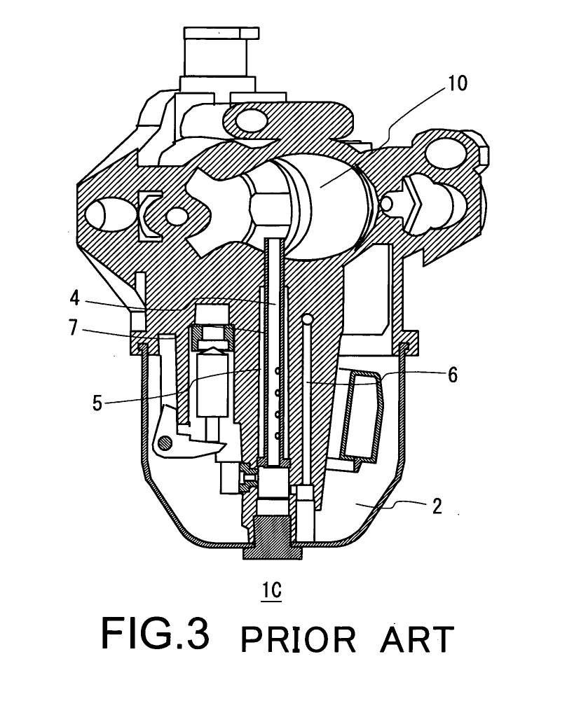

FIG. 1 is a transverse sectional view showing a carburetor 1A horizontally cut along the position of a suction passage 10 in the present embodiment. The carburetor 1A is substantially common with the above-mentioned carburetor 1C in its basic constitution, and the sectional structure thereof is similar to that shown in FIG. 3 of the above-mentioned conventional example. Therefore, the carburetor can be prepared simply by slightly modifying the conventional carburetor 1C, but hereinafter the characteristic part of the present invention will be described in detail.

The carburetor 1A is a side draft type carburetor for an engine, and has a substantially tubular main body through which the suction passage 10 transversely extends above a float chamber including a vertically provided columnar member (not shown) through which a vertical main fuel passage 4 extends. FIG. 1 shows a case where a throttle valve 12 and a choke valve 13 are set to an engine full load operation state.

A venturi part 8 is formed substantially in the center of the suction passage 10 so as to decrease the inner diameter of the passage, and on the downstream side slightly from the narrowest portion of the venturi part, a main nozzle 7 projects, whereby the main fuel passage 4 opens. Moreover, in a wall member of the main body made of a metal and surrounding the suction passage 10, a main air bleed passage 14 and a slow air bleed passage 9 are transversely arranged so as to sandwich the suction passage 10 therebetween, and the slow air bleed passage 9 joins a slow fuel passage 6 through an opening of a slow jet nozzle 6a, becomes a slow port 11 on the downstream side, and opens in the vicinity of the throttle valve 12 of the suction passage 10.

Furthermore, in the carburetor 1A of the present embodiment, the slow air bleed passage 9 is branched in the wall member near the venturi part 8, and has a slow air intake port 9A opened at a position of the narrowest portion of the venturi part 8 and a conventional slow air intake port 9B closed on the upstream side.

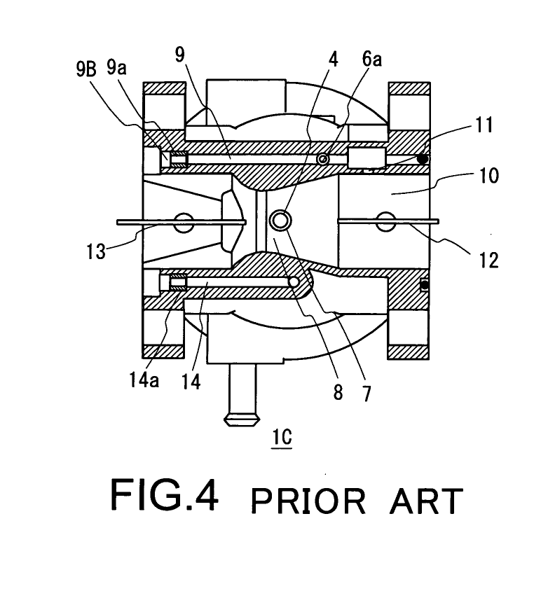

Here, in the conventional carburetor 1C shown in FIG. 4, the slow air intake port 9B opens in a large-diameter portion of the suction passage 10 on the upstream side, and the slow port 11 opens in a large-diameter portion of the suction passage 10 on the downstream side, so that there is a problem that the air flowing through the slow air intake port 9B and the slow port 11 flows into the main nozzle 7 to dilute an air-fuel mixture, thereby causing engine disorder.

On the other hand, in the present embodiment, the conventional slow air intake port 9B is closed, and the slow air intake port 9A is provided so as to open in the narrowest portion of the venturi part 8 in which the negative pressure becomes largest in the suction passage 10, whereby the slow negative pressure of this part becomes equal to or larger than the negative pressure in the opening of the main fuel passage 4. In consequence, a pressure difference between both the pressures is eliminated to prevent the air from flowing into the main fuel passage 4 through the slow air intake port 9A and the slow port 11, whereby excessive air is not mixed with a supplied fuel.

Thus, according to the present embodiment having a simple constitution obtained by slightly modifying the conventional carburetor, the occurrence of back bleed can be prevented in any operating situation including an engine high-speed rotation region.

FIG. 2 is a transverse sectional view of a carburetor 1B as an application example of the carburetor 1A in the embodiment shown in FIG. 1. The slow air intake port 9A which opens in the narrowest portion of the venturi part 8 and the conventional slow air intake port 9B are used together, and also in this case, the largest negative pressure is applied to the slow air intake port 9A in the narrowest portion of the venturi part 8, so that a back bleed prevention effect can similarly be expected. It is to be noted that in this case, when the carburetor is manufactured by modifying the conventional carburetor, the number of manufacturing steps decreases as compared with the carburetor 1A shown in FIG. 1, thereby further decreasing cost.

As described above, in the carburetor including the slow fuel passage branched from the main fuel passage, the back bleed can be prevented by the simple constitution according to the present invention.

1. A carburetor for an engine in which a slow air intake port to introduce air into a slow air bleed passage opens on the side of a suction passage; a slow fuel passage is connected in the middle of a main fuel passage on the upstream side, joins the slow air bleed passage on the downstream side, and has an open end on the side of the suction passage; and the main fuel passage opens in a state where a main nozzle projects in a venturi part of the suction passage,
wherein the slow air intake port is opened at a predetermined position of the venturi part having an inner diameter equal to or less than that of the suction passage at a position where the main fuel passage opens.

2. The carburetor according to claim 1, wherein the slow air intake port opens in the narrowest portion of the venturi part.

3. The carburetor according to claim 1, wherein the slow air intake ports open at two portions of the venturi part and a position on the upstream side of the venturi part.

4. The carburetor according to claim 2, wherein the slow air intake ports open at two portions of the venturi part and a position on the upstream side of the venturi part.
